(19) United States
(12) Patent Application Publication
(10) Pub. No.: US 2015/0379379 A1
(43) Pub. Date: Dec. 31, 2015

(54) Printing Apparatus And Print Control Device

(71) Applicant: Seiko Epson Corporation, Tokyo (JP)

(72) Inventors: Hiroaki Kubota, Matsumoto-shi (JP); Masahiro Nakayama, Shiojiri-shi (JP)

(21) Appl. No.: 14/739,268

(22) Filed: Jun. 15, 2015

(30) Foreign Application Priority Data
Jun. 25, 2014 (JP) 2014-129973

(51) Int. Cl. G06K 15/02

(52) U.S. Cl. CPC G06K 15/1806

(57) ABSTRACT

A printer includes a storage unit that spools print jobs, a print job sorting unit that sorts the spooled print jobs into a processing order, and a printing unit that performs printing on a paper roll in response to the print jobs in the sorted processing order. The print job sorting unit sorts the print jobs into a processing order based on medium attributes of the paper roll supplied to the printing unit and medium attributes which are requested in the print job.

### BACKGROUND

1. Technical Field

The present invention relates to a printing apparatus and a print control device.

2. Related Art

In the related art, a printing apparatus that performs printing (recording) on a printing medium (paper roll) supplied in a rolled state is known. The paper roll has merit in that a length (printing length) of one image to be printed can be variable and increased and merit in that a length to be prepared by winding paper in a roll shape is further increased and thus, printing can be longer and continually performed. Therefore, in order to further enhance effects of characteristics of the merit, there is a demand for a printing apparatus that can perform more stable (with less human assistance) and more efficiently continual (with a shorter amount of length which is wastefully discarded) printing.

A printing apparatus disclosed in JP-A-2013-240891 can perform continual printing on paper rolls accommodated in upper and lower roll holders in which, when the printing is performed on one paper roll, it is possible to replenish a new paper roll or to replace with a different type of paper roll to a roll holder in which the other paper roll is accommodated. In addition, such a printing apparatus includes a rewinding mechanism on the upstream side (roll holder side) in a transport path of the paper roll, in addition to a loading mechanism that supplies the paper roll from the roll holder to a print section in which the printing is performed and thus, it is possible for an automatic change to be performed from the one paper roll on which the printing has been performed to another paper roll on which printing is newly performed. For example, in a case where a plurality of print jobs which cause a predetermined image to be printed as a predetermined number of copies based on a predetermined specification are stored and concurrently can be accepted one after another, it is possible to automatically change the paper rolls and to continue printing without human assistance even in a case where the printing medium which is requested in the respective print jobs is changed from the one paper roll to the other paper roll.

However, as in the printing apparatus described above, in a case where the plurality of print jobs are stored and continual printing is performed while the paper rolls are automatically changed, a problem arises in that time taken for changing the paper rolls results in a low printing efficiency.

### SUMMARY

The invention can be realized in the following application examples or forms.

### Application Example 1

According to this application example, there is provided a printing apparatus including: a storage unit that spools a print job; a print job sorting unit that sorts the spooled print jobs into a processing order; and a printing unit that performs printing on a printing medium in response to the print jobs in the sorted processing order. The print job sorting unit sorts the print jobs into a processing order based on medium attributes of the printing medium supplied to the printing unit and medium attributes which are requested in the print job.

In this case, the printing apparatus includes the storage unit that spools a print job, the print job sorting unit that sorts the spooled print jobs into the processing order, and the printing unit that performs printing on the printing medium in response to the print jobs in the sorted processing order. Since continuous printing is performed in response to the spooled print jobs, it is possible for the printing apparatus to perform the continual printing depending on the number of the print jobs.

In addition, the print job sorting unit sorts the print jobs into the processing order based on the medium attributes of the printing medium supplied to the printing unit and the medium attributes which are requested in the print job. In other words, it is possible to sort the spooled print jobs in accordance with the printing medium of a printing target supplied to the printing unit.

### Application Example 2

The printing apparatus according to the application example may further include a plurality of accommodating units that each accommodate a printing medium; and a printing medium supplying unit that supplies the printing medium to the printing unit from one of the plurality of accommodating units. The printing medium supplying unit may supply the printing medium to the printing unit from the accommodating unit in which the printing medium selected based on medium attributes that are requested in the print job in the sorted processing order is accommodated.

In this case, the printing apparatus further includes the plurality of accommodating units that each accommodate a printing medium and the printing medium supplying unit that supplies the printing medium to the printing unit from one of the plurality of accommodating units. In other words, it is possible for the printing apparatus to select a printing medium from the plurality of printing media and to perform printing thereon.

In addition, the printing medium supplying unit supplies the printing medium to the printing unit from the accommodating unit in which the printing medium selected based on the medium attributes that are requested in the print job in the sorted processing order is accommodated. In other words, it is possible for the printing apparatus to perform printing on printing media which is supplied in response to the sorted print jobs, that is, to perform printing in response to the sorted print jobs.

### Application Example 3

In the printing apparatus according to the application example, the print job sorting unit may sort the print jobs in a processing order such that printing media changing is performed the minimum number of times through which the printing medium that is different from the printing medium supplied to the printing unit is supplied to the printing unit by the printing medium supplying unit.

In this case, the print job sorting unit sorts the print jobs in a processing order such that printing media changing is performed the minimum number of times through which the printing medium that is different from the printing medium supplied to the printing unit is supplied to the printing unit by the printing medium supplying unit. For example, in a case where the plurality of print jobs are spooled in the storage unit and the print jobs request a plurality of types of printing media as the printing targets, respectively, the printing medium which is supplied to the printing unit needs to be switched to another in accordance with the print jobs in order to complete every print job. In this case, since the print jobs are sorted into the processing order such that the switching is performed the minimum number of times (the number of printing media changes), shorter time (total time) is taken for switching (change of the printing media).

In addition, in a case where the printing medium is a paper roll, the paper roll needs to be cut in response to the switching; however, since the minimum number of times switching is performed, it is possible for the wasteful region in the vicinity of the cutting to become smaller.

### Application Example 4

In the printing apparatus according to the application example, the printing medium sorting unit may sort the print jobs into a processing order of a print job in which printing is requested on the printing medium supplied to the printing unit, a print job in which printing is requested on one printing medium accommodated in the plurality of accommodating units, and a print job in which printing is requested on the printing medium which is not accommodated any of the plurality of accommodating units.

In this case, the printing medium sorting unit sorts the print jobs into a processing order of prioritizing, first, the print job in which printing is requested on the printing medium supplied to the printing unit, second, the print job in which printing is requested on one printing medium accommodated in the plurality of accommodating units, and next, the print job in which printing is requested on the printing medium which is not accommodated any of the plurality of accommodating units. For example, new print jobs are added one after another, in a case where the print jobs are sorted in this order such that the change of the printing media from the printing medium on which printing is being performed to another printing medium is decreased in frequency. In addition, when a print job is executed on the printing medium which is not accommodated in any one of the plurality of accommodating units, the corresponding printing medium needs to be set in any one of the accommodating units. In this manner, the print job that requires human assistance (replacement operation of the printing medium accommodated in the accommodating unit) is delayed and thereby it is possible to more efficiently perform the operation because the human assistance can be provided at once.

### Application Example 5

In the printing apparatus according to the application example, the medium attributes requested in the print job may include media width requesting information which requests a length of the printing medium in a width direction and the print job sorting unit may prioritize the printing medium that has a value of a width of the selected printing medium which exceeds a value requested from the media width requesting information in a smaller amount in a case where a plurality of the printing media correspond to a request in the print job and may sort the print jobs in a processing order.

In this case, the medium attributes (that is, information or the like which specifies (designates) the printing medium on which the printing is performed) requested in the print job includes media width requesting information which requests the length of the printing medium in the width direction and the print job sorting unit prioritizes the printing medium that has the value of the width of the selected printing medium which exceeds a value requested from the media width requesting information in the smaller amount in a case where the plurality of the printing media correspond to the request in the print job and sorts the print jobs in the processing order. As a result, since a region (region beyond a printing target range in the width direction) in which printing is not performed on the printing medium becomes narrower, it is possible to decrease the size of the wasteful region which is produced.

### Application Example 6

A print control device according to this application example transmits a print job to a printing apparatus which performs printing on a printing medium in response to the received print job. The print control device includes: a storage unit that spools the print job; and a print job sorting unit that sorts the spooled print jobs in an order in which the print jobs are transmitted to the printing apparatus. The print job sorting unit sorts the print jobs in an order in which the print jobs are transmitted to the printing apparatus based on medium attributes that are requested in the print job most recently transmitted to the printing apparatus and medium attributes which are requested in the print job spooled in the storage unit.

In this case, the print control device transmits the print job to the printing apparatus which performs printing on the printing medium in response to the received print job. The print control device includes the storage unit that spools the print job and the print job sorting unit that sorts the spooled print jobs in an order in which the print jobs are transmitted to the printing apparatus. Therefore, the print control device transmits the spooled print jobs to the printing apparatus in the order and thereby, it is possible to continually operate the printing apparatus.

In addition, the print job sorting unit sorts the print jobs in the order in which the print jobs are transmitted to the printing apparatus based on the medium attributes that are requested in the print job most recently transmitted to the printing apparatus and the medium attributes which are requested in the print job spooled in the storage unit. In other words, it is possible to sort the spooled print jobs in accordance with the printing medium on which the printing apparatus performs the printing.

### BRIEF DESCRIPTION OF THE DRAWINGS

The invention will be described with reference to the accompanying drawings, wherein like numbers reference like elements.

FIG. 1 is a perspective view of a printing apparatus according to Embodiment 1.

FIG. 2 is a conceptual diagram illustrating a transport path of a printing medium.

FIG. 3 is a functional block diagram of the printing apparatus.

FIGS. 4A and 4B are diagrams of print job sorting images.

FIG. 5 is a list showing relationships between setting performed on an operation panel and information contained in print jobs.

FIG. 6 is a functional block diagram of a print control device.

### DESCRIPTION OF EXEMPLARY EMBODIMENTS

Hereinafter, an embodiment of the invention will be described with reference to the drawings. The following description is provided only for an embodiment of the invention, and the invention is not limited thereto. In the following drawings, in order for the description to be easily understandable, the size in the description is different from an actual size in some cases. In addition, in a coordinate system in the drawings, a Z axial direction is a vertical direction, a −Z direction is a perpendicular direction, a Y axial direction is a frontward-rearward direction, a +Y direction is a frontward direction, an X axial direction is a horizontal direction, a +X direction is a left direction, and an X-Y plane is a plane which is horizontally parallel to a floor.

### Embodiment 1

### Printing Apparatus

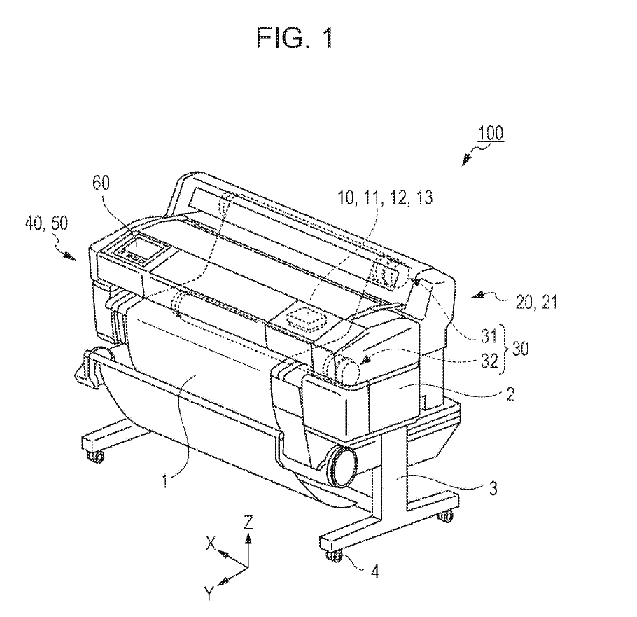

FIG. 1 is a perspective view of a printer 100 as a printing apparatus according to Embodiment 1.

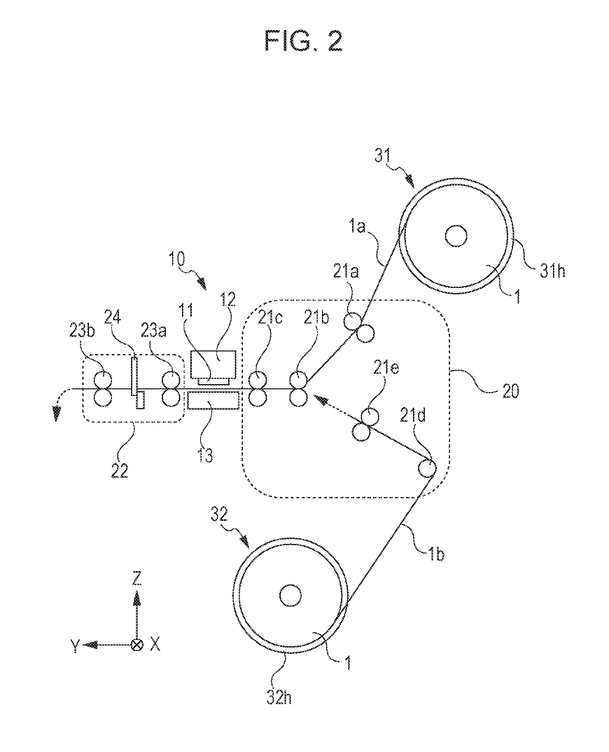

FIG. 2 is a conceptual diagram of a transport path of a printing medium inside the printer 100.

For example, the printer 100 is a large-sized ink jet type printer which is able to perform printing on a printing medium of a relatively large size such as A0 size or B0 size in JIS standards. The printing medium is supplied in a state of being wound in a roll shape (hereinafter, the printing medium is referred to as a paper roll 1).

The printer 100 is configured to include an apparatus body 2, a stand 3 that supports the apparatus body 2, or the like. The apparatus body 2 is configured to include a printing unit 10, a paper roll removing and supplying unit 20, a paper roll accommodating unit 30, a storage unit 40, a controller 50, an operation panel 60, an input/output interface (not illustrated) to an external device, and the like. The stand 3 includes a plurality of casters 4 on the lower end thereof, which enable the printer 100 to move on a floor and the apparatus body 2 is mounted and supported on the upper section of the stand 4.

The printing unit 10 includes an ink jet head 11 which discharges ink and prints an image on a surface of the paper roll 1, a carriage 12 which supports the ink jet head 11 and causes the ink jet head to move over and scan the surface of the paper roll 1, a stage 13 which supports the paper roll 1 in the printing unit 10, and the like.

The paper roll removing and supplying unit 20 includes a plurality of transport rollers 21 (21a to 21e in FIG. 2) which supply the paper roll 1 accommodated in the paper roll accommodating unit 30 before printing is performed thereon to the printing unit 10, or which return the paper roll 1 to the paper roll accommodating unit 30 side from the printing unit 10. The transport rollers 21 are provided at a plurality of positions so as to form the transport path (path to the printing unit 10) of the paper roll 1 inside the apparatus body 2 and are configured of drive rollers, driven rollers which are driven following the drive rollers and guide the paper roll 1, or the like.

In addition, the paper roll removing and supplying unit 20 is configured for the paper roll 1 to be smoothly transported (supplied to the printing unit 10 and rewound on the paper roll accommodating unit 30 side) between the respective transport rollers 21 in the transport path. Specifically, as shown by the transport rollers 21a to 21c and 21e in FIG. 2, the transport rollers 21 are configured of the drive rollers and the driven rollers which are disposed to be biased such that the paper roll 1 is interposed between the drive rollers and the driven rollers at several positions as necessary. In addition, the paper roll removing and supplying unit 20 includes a guide unit (not illustrated) which regulates a position of the paper roll such that the paper roll 1 is smoothly transported between the transport rollers 21. For example, in FIG. 2, an example of the guide unit includes a guide plate or the like that enables a leading end of the paper roll 1 to be smoothly inserted between the drive roller and the driven roller which configure the transport rollers 21b in a case where the paper roll 1 is transported from the transport rollers 21a to the transport rollers 21b, or from the transport rollers 21e to the transport rollers 21b.

The paper roll accommodating unit 30 includes a first accommodating unit 31 provided in an upper rear side of an apparatus body 2 and a second accommodating unit 32 disposed on the lower side of the apparatus body 2. The paper rolls 1 before printing is performed thereon can be accommodated in the first accommodating unit 31 and the second accommodating unit 32, respectively. In addition, different types (material properties, sizes, or the like) of paper rolls 1 can be accommodated in the accommodating units, respectively.

The first accommodating unit 31 includes a pair of holders 31h which hold the paper roll 1 from both sides in the axial direction thereof. In addition, the first accommodating unit 31 includes motors (not illustrated) which transmit rotative power to the holders 31h and driving of the motors causes the paper roll 1 held by the holders 31h to rotate and thereby, the paper roll 1 to be unrolled or to be rewound. Similarly, the second accommodating unit 32 includes a pair of holders 32h which hold the paper roll 1 from both sides in the axial direction thereof. In addition, the second accommodating unit 32 includes motors (not illustrated) which transmit rotative power to the pair of holders 32h and driving of the motors causes the paper roll 1 held by the holders 32h to rotate and thereby, the paper roll 1 to be unrolled or to be rewound.

The storage unit 40 is a rewritable storage medium such as a hard disk drive (HDD) or a memory card. Software (a program) or a print job which causes the controller 50 to operate is stored in the storage unit 40.

The print job corresponds to information related to a series of requests (to be described below in detail) for printing to be performed and can be spooled in the storage unit 40. The spooled print jobs are executed in a sorted execution order as necessary.

The controller 50 includes a CPU (operation unit) and a storage unit (not illustrated) such as a RAM and a ROM and performs centralized control of the entire printer 100. In addition, as functions thereof, a print job receiving unit 51, a print job sorting unit 52, and a print control unit 53 are configured.

The operation panel 60 is an input/output unit as a human interface and includes a display and an input section. It is possible to perform designation or selection of the controller 50.

The printer 100 (paper roll removing and supplying unit 20) supplies either one paper roll 1 of the paper rolls 1 accommodated in the first accommodating unit 31 and the second accommodating unit 32, respectively, to the printing unit 10 such that printing is performed. Which the paper roll 1 which is used (selection of the paper roll 1 to be used) depends on a request in the print job to be executed or setting performed (selection) through the operation panel 60.

The paper roll 1 enters the printing unit 10 through the paper roll removing and supplying unit 20 from the first accommodating unit 31 or the second accommodating unit 32 and is discharged through a discharge unit 22 after printing is performed. The discharge unit 22 includes a plurality of transport rollers 23 (23a and 23b in FIG. 2) which discharge the paper roll 1 from the printing unit 10 after printing is performed. The transport rollers 23 are provided at a plurality of positions so as to form a discharge path of the paper roll 1 inside the apparatus body 2 and are configured of a drive roller, a driven roller which is driven following the drive roller and guide the paper roll 1, or the like.

In addition, the discharge unit 22 includes a cutter 24 for cutting the paper roll 1.

When the paper roll 1 which is accommodated in the first accommodating unit 31 is referred to as a paper roll 1a and the paper roll 1 which is accommodated in the second accommodating unit 32 is referred to as a paper roll 1b, as illustrated in FIG. 2, the paper roll 1a includes the transport path from the first accommodating unit 31 through the transport roller 21a, the transport roller 21b, the transport roller 21c, and the printing unit 10 that the paper roll 1a enters, to the transport roller 23a and the transport roller 23b through which the paper roll 1 is discharged. In addition, the paper roll 1b includes the transport path from the second accommodating unit 32 through the transport roller 21d, the transport roller 21e, the transport roller 21b, the transport roller 21c, and the printing unit 10 that the paper roll 1b enters, to the transport roller 23a and the transport roller 23b through which the paper roll 1 is discharged.

For example, in a case where switching of the printing medium (paper roll 1) is performed from the paper roll 1a to the paper roll 1b, the paper roll 1a in a region in which on which printing is performed is transported out (discharged) to the downstream side from a cutting position of the cutter 24 and the paper roll 1a is cut by the cutter 24. Next, the paper roll 1a positioned on the upstream side from the cutting position is first rewound until the leading end position thereof is set in a region between the transport roller 21a and the transport roller 21b. The transport rollers 21a, 21b, 21c, 23a, and 23b and the motor which is included in the first accommodating unit 31 cause the rewinding to be performed under the control of the controller 50.

Next, the paper roll 1b has a leading end position set in a region between the transport roller 21e and the transport roller 21b, is guided to the transport rollers 21b, 21c, and 23a in this order, and is set in the printing unit 10.

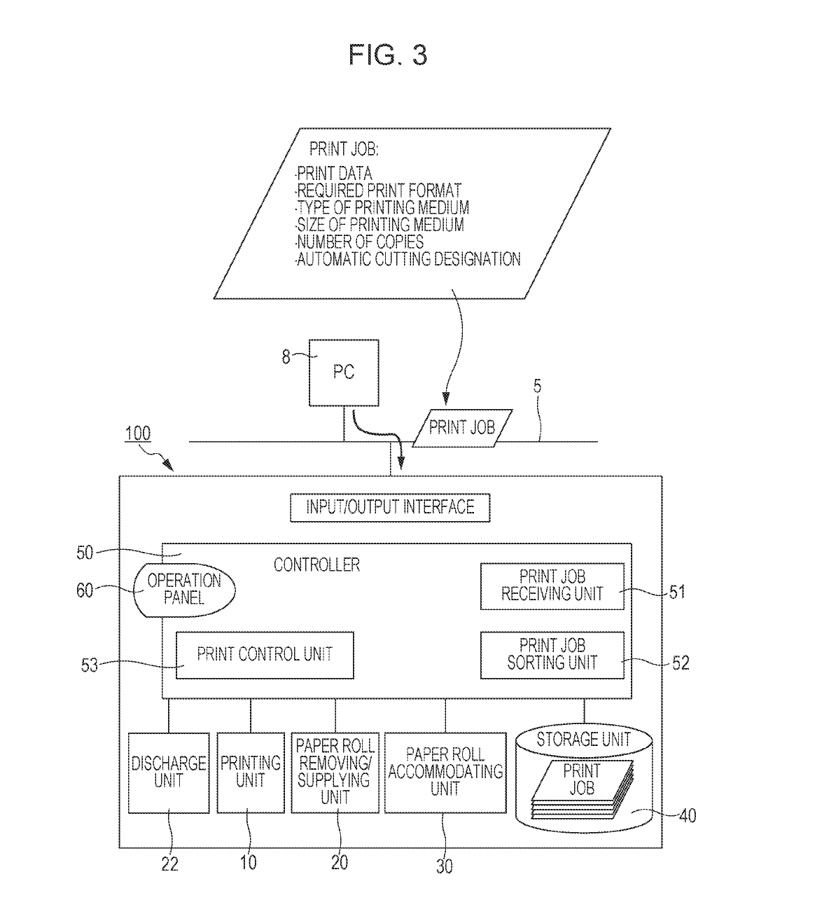

FIG. 3 is a functional block diagram of the printer 100.

The printer 100 is connected, directly or through a network 5, to a personal computer 8 (hereinafter, PC 8) through the input/output interface. The print job executed in the printer 100 can be input (received) from the PC 8, for example. Examples of the network 5 include a wired or wireless LAN, the Internet, a public line, a private line, and the like.

The printer 100 includes the print job receiving unit 51, the print job sorting unit 52, the print control unit 53, and the like as the functions of the controller 50.

The print job receiving unit 51 receives a print job transmitted from the PC 8 and spools the print job in the storage unit 40.

The print job sorting unit 52 sorts the spooled print jobs in a processing order as necessary. The sorting of the print jobs is described below.

The print control unit 53 performs printing processes on the printing medium (paper roll 1) in the processing order of the sorted print jobs. Specifically, the print control unit 53 performs drive control of the paper roll accommodating unit 30, the paper roll removing and supplying unit 20, the printing unit 10, and the discharge unit 22 such that a desired image is printed on the paper roll 1.

### Print Job

The print job corresponds to printing request information which is sent to the printer 100 by the PC 8 and contains, for example, print data, a print format, a type of printing medium, a size of a printing medium, the number of copies, automatic cut designation, or the like.

The print data is used to form an image which is printed and includes one or both of, for example, general-purpose image data (for example, RGB data) which is acquired using an image acquiring device such as a digital camera and data obtained by converting the general-purpose image data to printer control data (for example, control code of ESC/P (registered trademark, Epson Standard Code for Printer) by which the printer 100 is driven.

The print format corresponds to information which designates a format when printing is performed on the printing medium and contains information related to, for example, a size of a margin, a changed or unchanged size, and the like.

The information of the type of printing medium corresponds to the information that designates the paper roll 1, for example, in a case where different types of paper rolls 1 are set in the paper roll accommodating unit 30, in a case where the printing can be performed on the paper roll which is not set by setting the paper roll. Information of designation of a plurality of paper rolls 1 on which printing can be performed, changed or unchanged size, or the like may be contained therein. As the information which designates the paper roll 1, information which designates hardware that transports the paper roll 1, in addition to the information representing the type of paper roll 1 (model number, product name, or the like of the paper roll 1) may be adopted. For example, the information (information which designates either the first accommodating unit 31 or the second accommodating unit 32) which designates the paper roll accommodating unit 30 or information (information which designates either the transport roller 21a side or the transport roller 21e side) which designates the transport path may be adopted.

The information of the printing medium size corresponds to “media width requesting information” which requests a length of the paper roll 1 in the width direction and means information which limits the size of the paper roll 1 to a designated size (designated width) or information which limits the paper roll 1 to the paper roll 1 having a permitted range of sizes. The information of the printing medium size may contain information of designation of a plurality of paper rolls 1, a plurality of sizes or permitted ranges of a size, changed size or unchanged size, or the like.

The information of the number of copies corresponds to information which designates the number of images which are printed from the print job. In a case where an image is formed as a set of a plurality of images, the number of sets is designated.

The information of automatic cutting designation corresponds to information of whether or not cutting with the cutter 24 is performed, information which designates a cutting position, or the like.

### Print Job Sorting

In the printing apparatus having the configuration described above, when switching between the selectable printing media (paper rolls 1) is performed and concurrent printing is performed, the printer 100 of the present embodiment sorts the print jobs spooled in the storage unit 40 into a processing order and thereby, the minimum (or smaller number) number of times switching is performed.

Specifically, the print job sorting unit 52 performs sorting of the print jobs such that the print job which is fulfilled with the paper roll 1 (hereinafter, referred to as an active paper roll), as a target, which is supplied to the printing unit 10 is prioritized. Therefore, the print job in which printing is requested on the active paper roll is prioritized and the sorting is performed. Next, the print job in which printing is requested on the other paper roll 1 (hereinafter, referred to as an inactive paper roll) accommodated in the paper roll accommodating unit 30 (second accommodating unit 32 in a case where the active paper roll is supplied from the first accommodating unit 31 and the first accommodating unit 31 in a case where the active paper roll is supplied from the second accommodating unit 32) is prioritized and sorting is performed. In addition, the print job in which printing is requested on the paper roll 1 (hereinafter, referred to as an unaccommodated paper roll) which is not accommodated in either the first accommodating unit 31 or the second accommodating unit 32 has the next priority and the sorting of the print jobs is performed.

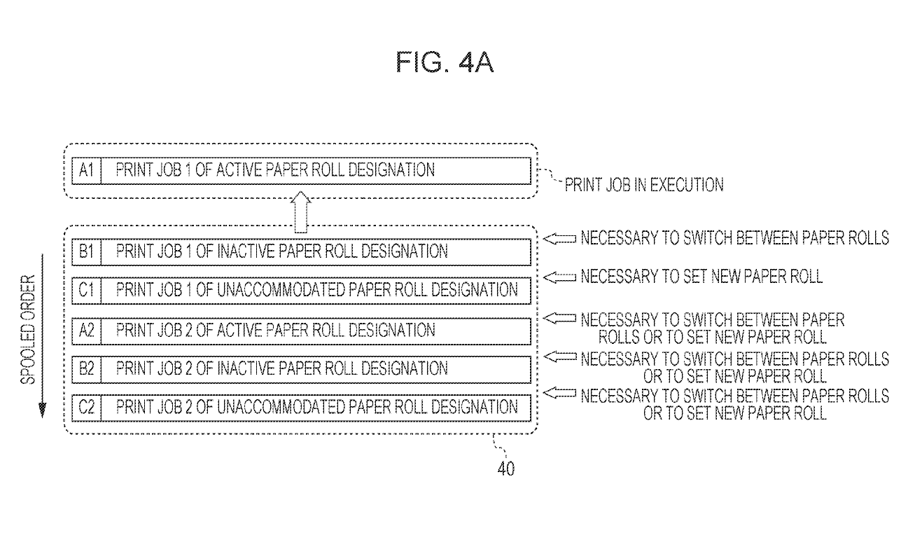

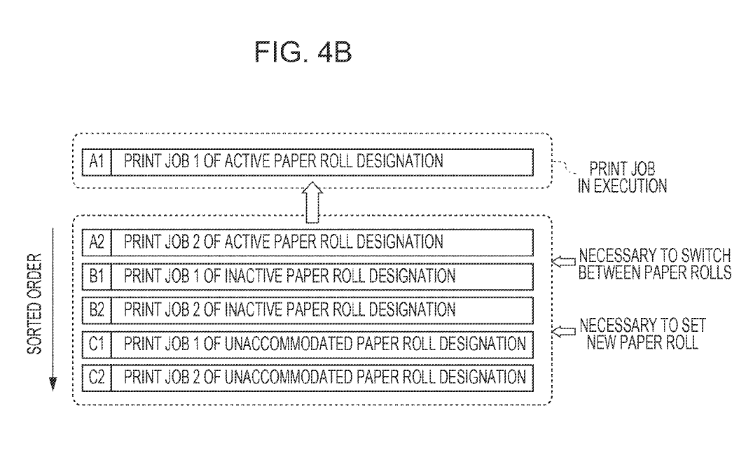

FIGS. 4A and 4B are diagrams of print job sorting images.

FIG. 4A illustrates a state in which six print jobs (A1, B1, C1, A2, B2, and C2) are spooled in the storage unit 40 in this order and the first spooled print job A1 is executed without sorting. Hence, the paper roll 1 as a target of the print job A1 becomes the active paper roll.

Here, for example, the six respective print jobs (A1, B1, C1, A2, B2, and C2) are the print job A1 of designating the active paper roll, the print job B1 of designating the inactive paper roll, the print job C1 of designating the unaccommodated paper roll, the print job A2 of designating the active paper roll, the print job B2 of designating the inactive paper roll, the print job C2 of designating the unaccommodated paper roll.

In a case where the sorting of the print jobs is not performed, as illustrated in FIG. 4A, switching of the paper rolls 1 needs to be performed when the print job B1 is started after the print job A1 is finished. In addition, when the print job C1 is performed after the print job B1, there is a need to set a new paper roll 1 in either the first accommodating unit 31 or the second accommodating unit 32. Similarly, when the print job A2 is performed after the print job C1, the print job B2 is performed after the print job A2, and the print job C2 is performed after the print job B2, there is a need to switch or to set the paper roll 1.

The switching between the paper rolls 1 can be automatically performed using a function of the printer 100; however, setting of the new paper roll 1 in either the first accommodating unit 31 or the second accommodating unit 32 needs to be performed with human assistance.

In contrast, in the present embodiment, the print jobs are sorted in a processing order based on medium attributes of the active paper roll and medium attributes which are requested in the print job. Specifically, the print job sorting unit 52 sorts the print jobs with reference to information of types or sizes of active paper rolls and information of types or sizes of paper rolls 1 which are contained in the print job.

The information of the type and size of an active paper roll is obtained from the information of the type and size of paper roll 1 which is contained in the latest-performed print job or is obtained from information which is input when the printer 100 is set up. The information which is input when the printer 100 is set up is information such as the medium attributes of the paper roll 1 which is input through the operation panel 60 when the paper roll 1 is set in ether the first accommodating unit 31 or the second accommodating unit 32.

The print job sorting unit 52 sorts the print jobs in the processing order of the print job in which printing is requested on the active paper roll, a print job in which printing is requested on the inactive paper roll, and a print job in which printing is requested on the unaccommodated paper roll.

FIG. 4B illustrates print jobs after sorting is performed thereon. The print jobs are sorted in this manner and thereby, there is no need to switch between the paper rolls 1 until printing on the active paper roll is completed. In addition, there is no need to set a new paper roll 1 until printing on both the active paper roll and the inactive paper roll is completed.

It is possible to set conditions (determination conditions) in which switching between the paper roll 1 or setting of a new paper roll 1 needs to be performed, in advance, under control of the controller 50 through the operation panel 60 or the like.

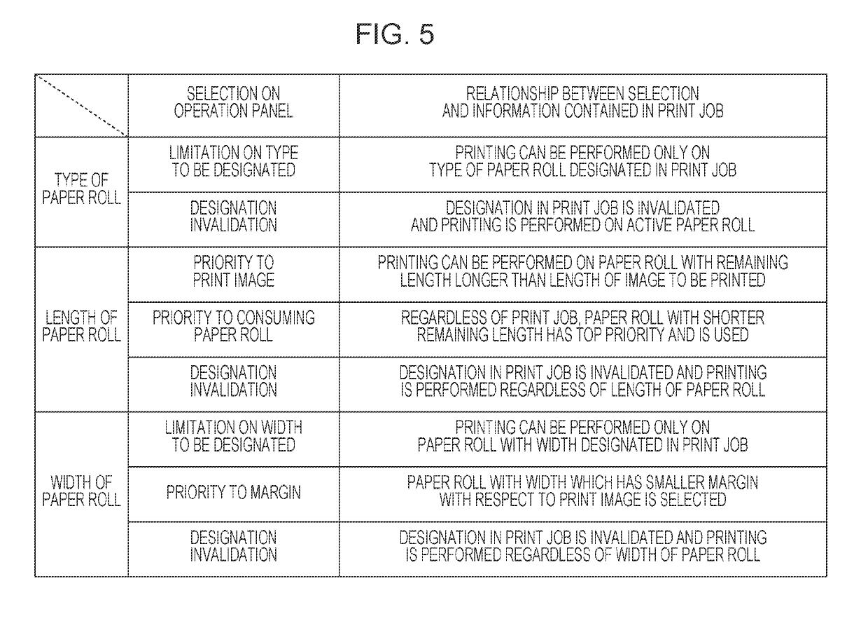

FIG. 5 illustrates relationships between setting performed (selection on a menu screen or the like) on the operation panel 60 and information contained in print jobs.

It is possible to perform setting of a switching condition related to the type, the length, the width, or the like of paper roll 1 on the operation panel 60. The selection through the operation panel 60 makes it possible to invalidate the printing conditions designated in the print job or to set priority or the like in a case where the printing conditions are valid.

For example, in a case where selection of “limitation on type to be designated” as the type of paper roll, selection of “priority to print image” as the length of the paper roll, and selection of “designation invalidation” as the width of the paper roll are performed on the operation panel 60, printing is performed in a case where a remaining length in which the print image is fitted is secured based on the type of paper roll 1 designated in the print job. For example, in a case where the active paper roll is designated; however, the remaining length is short and the same paper roll 1 is set as the inactive paper roll, and switching between paper rolls 1 from the active paper roll to the inactive paper roll is performed as a necessary print job.

In addition, for example, in a case where selection of “designation invalidation” as the type of paper roll 1, selection of “designation invalidation” as the length of the paper roll 1, and selection of “priority to margin” as the width of the paper roll 1 are performed, the print jobs are sorted in a processing order, with prioritization of the paper roll 1 that has a value of the width which exceeds a value requested based on the media width requesting information (information of a size of the printing medium in the print job) in a smaller amount. That is, the paper roll 1 having a width on which the margin becomes smaller is selected and the sorting is performed such that the minimum number (or smaller number) of switching is performed.

### Timing of Print Job Sorting

In a case where two or more print jobs are spooled in the storage unit 40 and in a case where the printer 100 is set to a mode of sorting implementation, the sorting of the print jobs spooled in the storage unit 40 is implemented at the following timings.

1) A Timing when the Sorting Implementation Mode is Set

The sorting implementation mode in which the print job sorting unit 52 sorts the print jobs spooled in the storage unit 40 can be set through the operation panel 60. For example, the setting is performed by causing the sorting implementation mode to become ON or the like through operation on a menu screen or the like under the control of the controller 50. The print job sorting unit 52 starts the sorting process based on input of sorting implementation mode ON.

2) A Timing when a New Print Job is Input

The print job receiving unit 51 receives the new print job and the print job sorting unit 52 starts the sorting process at the timing when two or more print jobs are spooled in the storage unit 40. In a case where two or more print jobs are spooled in the storage unit 40, sorting is performed whenever the new print job is newly spooled.

3) A Timing when a Condition of Switching Between the Printing Media is Changed

Whenever a condition (determination condition), under which it is determined that switching between paper rolls 1 or setting of a new paper roll 1 needs to be performed, is changed in setting (selection) performed on the operation panel 60, the sorting is performed in accordance with the newly set condition.

As will be described below, it is possible to achieve the following effects in the printing apparatus according to the present embodiment.

The printer 100 includes the storage unit 40 that spools a print job, the print job sorting unit 52 that sorts the spooled print jobs into the processing order, and the printing unit 10 that performs printing on the paper roll 1 in response to the print jobs in the sorted processing order. Since continuous printing is performed in response to the spooled print jobs, it is possible for the printer 100 to perform the continual printing depending on the number of the print jobs.

In addition, the print job sorting unit 52 sorts the print jobs into the processing order based on the medium attributes of the paper roll 1 (active paper roll) supplied to the printing unit 10 and the medium attributes which are requested in the print job. In other words, it is possible to sort the spooled print jobs in accordance with the active paper roll.

In addition, the printer 100 further includes the first accommodating unit 31 and the second accommodating unit 32 which each accommodate the paper roll 1 and the printing medium removing/supplying unit 20 that supplies the paper roll 1 to the printing unit 10 from either the first accommodating unit 31 or the second accommodating unit 32. In other words, it is possible for the printer 100 to select one from the plurality of paper rolls 1 and to perform printing thereon.

In addition, the printing medium removing/supplying unit 20 supplies the paper roll 1 to the printing unit 10 from the print job accommodating unit 30 in which the paper roll 1 selected based on the medium attributes which are requested in the print job in the sorted processing order is accommodated. In other words, it is possible for the printer 100 to perform printing on the paper roll 1 which is supplied in response to the sorted print jobs, that is, to perform printing in response to the sorted print jobs.

In addition, the print job sorting unit 52 sorts the print jobs in the processing order such that changing of paper rolls 1 is performed the minimum number of times through which the paper roll 1 that is different from the active paper roll is supplied by the pressure calculating means 20 to the printing unit 10. For example, in a case where the plurality of print jobs are spooled in the storage unit 40 and the print jobs request a plurality of types of paper rolls 1 as the printing targets, respectively, the paper roll 1 which is supplied to the printing unit 10 needs to be switched to another in accordance with the print jobs in order to complete every print job. According to the present embodiment, since the print jobs are sorted into the processing order such that the switching is performed the minimum number of times (the number of paper rolls 1 changing), shorter time (total time) is taken for switching (change of the paper roll 1).

In addition, the paper roll 1 needs to be cut in response to the switching; however, it is possible for wasteful regions in the vicinity of the cutting to become smaller because the cutting is performed the minimum number of times.

The printing medium sorting unit 52 prioritizes the print job in which printing is requested on the active paper roll and then, prioritizes the print job in which printing is requested on one paper roll 1 accommodated in the print job accommodating unit 30 (first accommodating unit 31, and second accommodating unit 32). In addition, the print jobs in which printing is requested on the paper roll 1 which is not accommodated in neither of the print job accommodating units 30 are sorted into the processing order of the print jobs as the second priority thereof. For example, in a case where new print jobs are added one after another, the print jobs are sorted in this order such that the change of the paper roll 1 (active paper roll) from the paper roll 1 on which printing is being performed to another paper roll 1 is decreased in frequency. In addition, when a print job is executed on the paper roll 1 which is not accommodated in neither of the paper roll accommodating units 30 (first accommodating unit 31 and second accommodating unit 32), the corresponding paper roll 1 needs to be set in either the first accommodating unit 31 or the second accommodating unit 32. In this manner, the print job that requires human assistance (replacement operation of the paper roll 1 accommodated in the paper roll accommodating units 30) is delayed and thereby it is possible to more efficiently perform the operation because the human assistance is collectively provided.

In addition, in the printer 100, the setting (selection) of the conditions under which it is determined that the switching between the paper rolls 1 or the setting of the new paper roll 1 needs to be performed on the operation panel 60. For example, in a case where selection of “designation invalidation” from the type of paper roll 1, selection of “designation invalidation” from the length of the paper roll 1, and selection of “priority to margin” from the width of the paper roll 1 are performed, the print jobs are sorted in a processing order, with prioritization of the selected paper roll 1 that has a value of the width which exceeds a value requested from the media width requesting information (information of a size of the printing medium in the print job) in a smaller amount. That is, the paper roll 1 having a width on which the margin becomes smaller is selected and the sorting is performed such that the minimum number (or smaller number) of times of switching is performed. As a result, since a region (region beyond a printing target range in the width direction) in which printing is not performed on the paper roll 1 becomes narrower, it is possible to decrease the size of the wasteful region which is produced.

### Embodiment 2

Next, a print control device according to Embodiment 2 will be described. The same reference signs are attached to the same components as in the embodiment described above and the description thereof is not repeated.

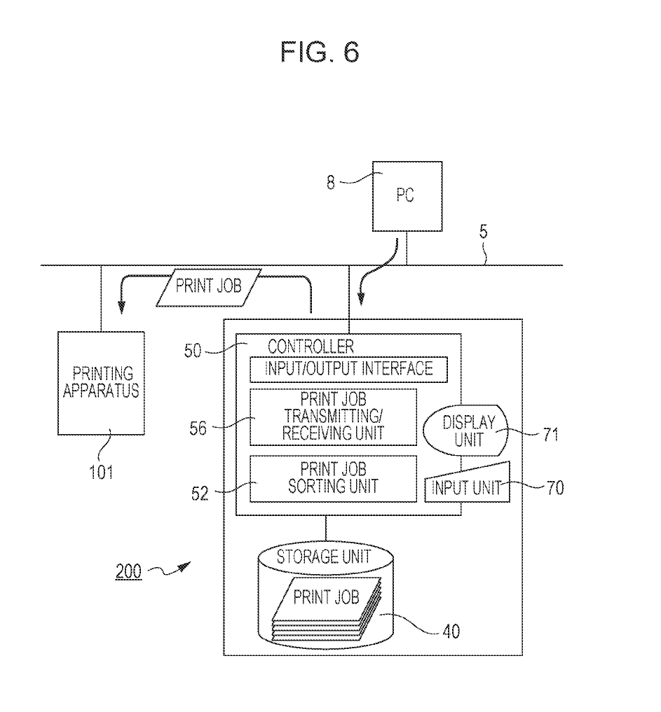

FIG. 6 is a functional block diagram of a printer control device 200 as a print control device.

The printer control device 200 corresponds to the print control device having a configuration in which the printing function omitted from the printer 100 described in Embodiment 1 and can transmit a print job to the printing function (printer 101) which is connected through a network 5.

The printer control device 200 includes an input unit 70 and a display unit 71 as a human interface, instead of the operation panel 60 included in the printer 100. In addition, instead of the print job receiving unit 51 included in the printer 100, the printer control device 200 includes a print job transmitting/receiving unit 56. For example, the printer control device 200 can be configured of a personal computer which includes a keyboard as the input unit 70, a display as the display unit 71, and an HDD as the storage unit 40 and includes the print job sorting unit 52 as a functional unit of the controller 50 and a print job transmitting/receiving unit 56.

The print job which is transmitted to the printer 101 by the printer control device 200 can be input (receive) from the PC 8 and can be generated in the printer control device 200.

In a case where the printer 101 performs switching between the paper rolls 1 which are supplied from the plurality of accommodating units similar to the printer 100 and performs printing, the printer control device 200 sorts the print jobs spooled in the storage unit 40 into the processing order and transmits the print jobs in the sorted order and thereby the switching is performed the minimum number of times (or smaller number of times) in the printer 101.

The print job sorting unit 52 included in the printer control device 200 sorts the print jobs into an order in which the print job are transmitted to the printer 101 based on the medium attributes of the active paper roll of the printer 101 and the medium attributes which are requested in the print job spooled in the storage unit 40. Specifically, the print job sorting unit 52 sorts the print jobs with reference to information of types or sizes of active paper rolls in the printer 101 and information of types or sizes of paper rolls 1 which is contained in the print job spooled in the storage unit 40 of the printer control device 200.

The medium attributes (information of type, size, or the like) can be obtained from the medium attributes of the paper roll 1 which are requested in the print job which has been most recently transmitted from printer 101.

The print job transmitting/receiving unit 56 includes a function of receiving the print job from PC 8 connected through the network 5 and of spooling in the storage unit 40 and a function of transmitting the print jobs sorted by the print job sorting unit 52 to the printer 101 in the sorted order.

In the description above, in the print control device according to the present embodiment, it is possible for the print control device to achieve the following effects.

The printer control device 200 corresponds to the print control device which transmits the print job to the printer 101 which performs printing on the paper roll 1 in response to the received print job. The printer control device 200 includes the storage unit 40 in which the print jobs are spooled and the print job sorting unit 52 which sorts the spooled print jobs into an order in which the print jobs are transmitted to the printer 101. Therefore, the spooled print jobs are transmitted to the printer 101 in the order and thereby the printer control device 200 can cause the printer 101 to perform a continuous operation.

In addition, the print job sorting unit 52 included in the printer control device 200 sorts the print jobs into the order in which the print jobs are transmitted to the printer 101 based on the medium attributes (for example, medium attributes which are requested in the print job which has been most recently transmitted to the printer 101) of the active paper roll of the printer 101 and the medium attributes which are requested in the print job spooled in the storage unit 40. In other words, it is possible to sort the spooled print jobs in accordance with the paper roll 1 on which the printer 101 performs printing. As a result, since it is possible to sort the print jobs into the processing order such that the number (number of paper roll 1 changes) of times of switching is performed is the minimum number of times, it is possible to shorten time taken for the switching (change of the paper roll 1). For example, in a case where the print job with respect to one paper roll and the print job with respect to the other paper roll are repeated alternately, it is possible to solve the problem of the longer replacement operation time for the paper roll which can no longer be ignored, compared to the printing time.

In addition, the paper roll 1 needs to be cut in response to switching; however, since the minimum number of times of switching is performed, it is possible for the wasteful region in the vicinity of the cutting to become smaller.

The entire disclosure of Japanese Patent Application No. 2014-129973, filed Jun. 25, 2014 is expressly incorporated by reference herein.

What is claimed is:

1. A printing apparatus comprising:
a storage unit that spools a print job;
a print job sorting unit that sorts the spooled print jobs into a processing order; and
a printing unit that performs printing on a printing medium in response to the print jobs in the sorted processing order,
wherein the print job sorting unit sorts the print jobs into a processing order based on medium attributes of the printing medium supplied to the printing unit and medium attributes which are requested in the print job.

2. The printing apparatus according to claim 1, further comprising:
a plurality of accommodating units that each accommodate a printing medium; and
a printing medium supplying unit that supplies the printing medium to the printing unit from one of the plurality of accommodating units,
wherein the printing medium supplying unit supplies the printing medium to the printing unit from the accommodating unit in which the printing medium selected based on medium attributes that are requested in the print job in the sorted processing order is accommodated.

3. The printing apparatus according to claim 2,
wherein the print job sorting unit sorts the print jobs in a processing order such that printing media switching is performed the minimum number of times through which the printing medium that is different from the printing medium supplied to the printing unit is supplied to the printing unit by the printing medium supplying unit.

4. The printing apparatus according to claim 2,
wherein the printing medium sorting unit sorts the print jobs into a processing order of a print job in which printing is requested on the printing medium supplied to the printing unit, a print job in which printing is requested on one printing medium accommodated in the plurality of accommodating units, and a print job in which printing is requested on the printing medium which is not accommodated in any of the plurality of accommodating units.

5. The printing apparatus according to claim 3,
wherein the medium attributes requested in the print job includes media width requesting information which requests a length of the printing medium in a width direction, and
wherein the print job sorting unit prioritizes the printing medium that has a value of a width of the selected printing medium which exceeds a value requested based on the media width requesting information in a smaller amount in a case where a plurality of the printing media corresponds to a request in the print job and sorts the print jobs in a processing order.

6. A print control device that transmits a print job to a printing apparatus which performs printing on a printing medium in response to the received print job, comprising:
a storage unit that spools the print job; and
a print job sorting unit that sorts the spooled print jobs in an order in which the print jobs are transmitted to the printing apparatus,
wherein the print job sorting unit sorts the print jobs in an order in which the print jobs are transmitted to the printing apparatus based on medium attributes that are requested in the print job lately transmitted to the printing apparatus and medium attributes which are requested in the print job spooled in the storage unit.
